(19) United States
(12) Patent Application Publication
(10) Pub. No.: US 2012/0314733 A1
(43) Pub. Date: Dec. 13, 2012

(54) METHOD OF ESTIMATING PSEUDORANGE, GNSS RECEIVING APPARATUS, AND MOBILE TERMINAL

(75) Inventors: Takaki Tominaga, Nishinomiya-City (JP); Takuji Yasumoto, Nishinomiya-City (JP)

(73) Assignee: FURUNO ELECTRONIC CO., LTD., Nishinomiya-City, Hyogo-Pref. (JP)

(21) Appl. No.: 13/581,255

(22) PCT Filed: Feb. 23, 2011
(86) PCT No.: PCT/JP2011/054023

§ 371 Date: Aug. 24, 2012

(30) Foreign Application Priority Data
Feb. 26, 2010 (JP) 2010-042853

(51) Int. Cl. H04B 1/707

(52) U.S. Cl. 375/147; 375/E01.002

(57) ABSTRACT

A pseudorange is estimately calculated in high accuracy without being influenced by multipath. Multipath is determined based on a C/No and a difference value DV(iv) that is a difference value between a time change of an observed pseudorange and a delta range (S101-S103). If multipath does not exist (S104: NO), an error variance of the pseudorange and an error variance of the delta range are set to fixed values, and a weight coefficient is determined (S105). If multipath exists (S104: YES), a variance of the difference value and the variance of the delta range are calculated (S106), a variance of the pseudorange is calculated (S107), and the weight coefficient is determined based on the calculated variances of the pseudorange and the delta range (S108). Further, the pseudorange is estimately calculated by a weighted hatch filter through using the determined weight coefficient (S109).

### TECHNICAL FIELD

The present invention relates to a method of estimately calculating a pseudorange through receiving positioning signals from GNSS satellites, and particularly relates to a method of estimately calculating a pseudorange by carrier smoothing a pseudorange obtained based on measurement values.

### BACKGROUND ART

Conventionally, many positioning apparatuses for receiving positioning signals from GNSS satellites and performing a positioning have been put into practical use and used on various kinds of mobile terminals.

For such positioning apparatuses, an improvement in positioning accuracy has been required, and in order to achieve this, the art so called carrier smoothing using carrier phase information has been used conventionally. Carrier smoothing is for calculating a current estimated pseudorange by using a pseudorange (observed pseudorange) that is directly calculated based on code phase information in received positioning signals, and an added value of a pseudorange (estimated pseudorange) estimated previously and a carrier phase change.

As one of such estimation calculation methods, a “weighted-hatch-filter” disclosed in Nonpatent Document 1 is used, for example. A weight coefficient is determined based on a variance of the observed pseudorange and a variance of the estimated pseudorange.

### REFERENCE DOCUMENTS OF CONVENTIONAL ART

Nonpatent Document 1: Kee, C., Walter, T., Enge, P., and Parkinson, B., “Quality Control Algorithms on WAAS Wide-Area Reference Stations”, Journal of The Institute of Navigation, Vol. 44, No. 1, Spring, 1997, pp. 53-62

### DISCLOSURE OF THE INVENTION

### Problems to be Solved by the Invention

However, when a tall construction and the like exist near the positioning apparatus, such as in an urban area, the positioning apparatus receives direct positioning signals from GNSS satellites as well as indirect positioning signal(s) which were reflected on, for example, the tall construction, and an error occurs in the pseudorange to be calculated. Such phenomena is referred to as multipath, and due to this influence of the multipath error, the observed pseudorange includes a large error.

Here, in the weighted hatched filter, because a steady value that is set based on empirical rules in advance is used as the weight coefficient, even if the conventional carrier smoothing described above is performed, during a period where multipath continuously occurs, the error of the pseudorange to be estimated enlarges and positioning accuracy degrades.

The present invention aims to realize a pseudorange estimating method with which a pseudorange can be estimately calculated in high accuracy without being influenced by multipath.

### SUMMARY OF THE INVENTION

The present invention relates to a method of estimating a pseudorange based on reception signals of GNSS positioning signals. The pseudorange estimating method includes calculating an observed pseudorange based on a code phase difference of the reception signals, measuring Doppler frequencies of the reception signals, and calculating an estimated pseudorange by using carrier smoothing of adding with weights, the observed pseudorange calculated based on the code phase difference, a previously estimated pseudorange, and a change of a carrier wave phase. The weight in the carrier smoothing is determined based on a change rate of the observed pseudorange and the Doppler frequency.

In this method, when the psudorange is estimately calculated by the carrier smoothing, the weighting based on the pseudorange change and the Doppler frequency is used. Here, although the detail is described later in “MODE OF CARRYING OUT THE INVENTION” by using FIG. 1, the pseudorange is based on a code phase and is easily influenced by multipath, and an error of the pseudorange enlarges under an environment where multipath exists and the pseudorange error reduces under an environment where multipath does not exist. On the other hand, the Doppler frequency is based on a carrier phase, is difficult to be influenced by multipath, and is stable regardless of the existence of multipath. Therefore, by using these difference values, a value reflecting only the influence of multipath can be obtained.

Therefore, the influence of multipath is loosened by performing the carrier smoothing using the value reflecting the influence of multipath according to an appearance of multipath without using the fixed value as the conventional case, and a highly accurate estimation calculation of the pseudorange becomes available.

Further, the weight in the carrier smoothing may be determined based on a difference value between the change rate of the observed pseudorange and the Doppler frequency, or a statistic of the difference values.

Further, the weight in the carrier smoothing may be determined based on the change rate of the observed pseudorange, the Doppler frequency, and the estimated pseudorange.

Further, the weight in the carrier smoothing may be determined based on a statistic of difference values between the change rate of the observed pseudorange and the Doppler frequency, and a statistic of the estimated pseudoranges.

In these methods, specific examples of weighting in the carrier smoothing is shown.

Further, the calculating the estimated pseudorange may include adding with the weights, a value based on the Doppler frequency alternative to the change of the carrier wave phase.

In this method, an example of a correction term in the carrier smoothing is shown. By using the value based on the Doppler frequency to be used in setting the weight, the change of the carrier wave phase is not required to be measured separately, and processing is simplified.

Further, this pseudorange estimating method of the invention may include detecting multipath contained in the reception signal. The calculating the estimated pseudorange may include determining, when multipath is detected in the detecting multipath, the weight in the carrier smoothing based on the change rate of the observed pseudorange and the Doppler frequency, and determining, when multipath is not detected, the weight in the carrier smoothing to be a predetermined value.

In this method, a method of setting the weight according to multipath is shown, and the coefficients described above is used only when multipath exists. This can easily set in advance to a value for estimating the pseudorange in high accuracy, the coefficient when in a state where, when multipath does not exist, the pseudorange can stably be obtained, and the carrier smoothing is performed. Therefore, when multipath does not exist, by using this fixed set value, the estimation calculation speed can be improved, and a processing load can be reduced. On the other hand, when multipath exists, by performing the coefficient setting described above, the pseudorange can be estimated in high accuracy even if multipath exists. In this manner, the processing load can be reduced according to the situation while estimating the pseudorange in high accuracy constantly.

### Effect of the Invention

According to this invention, a pseudorange can estimately be calculated in high accuracy even under an environment where multipath is caused. Thus, a highly accurate positioning result can be obtained.

### BRIEF DESCRIPTION OF THE DRAWINGS

FIGS. 1(A) and 1(B) are charts for describing influence on a pseudorange and a delta range due to multipath.

FIG. 2 is a chart for describing a method of determining an error variance that is used in a weighted hatch filter.

FIG. 3 is a chart showing pseudorange errors when a pseudorange estimation calculation method of an embodiment and a conventional pseudorange estimation calculation method are used.

FIG. 4 is a flowchart of the pseudorange estimation calculation method of the embodiment.

FIG. 5 is a block diagram showing a main configuration of a pseudorange estimating function system of the embodiment.

FIG. 6 is a block diagram showing a main configuration of a mobile terminal 100 having a pseudorange estimating function of the embodiment.

### MODE OF CARRYING OUT THE INVENTION

A pseudorange estimating method, and a pseudorange estimating program and a pseudorange estimating function system of realizing the method according to an embodiment of the invention are described with reference to the drawings. Note that, in this embodiment, although a GPS of a GNSS is described as an example, the method and configuration of this embodiment can also be applied to other similar positioning systems.

Further, in the following description, an example in which a weighted hatch filter is used as a linear equation of a state space model for estimating a pseudorange is shown. However, the method of the invention can be applied also to other filter operations in which a weight coefficient can be used, such as the Kalman filter.

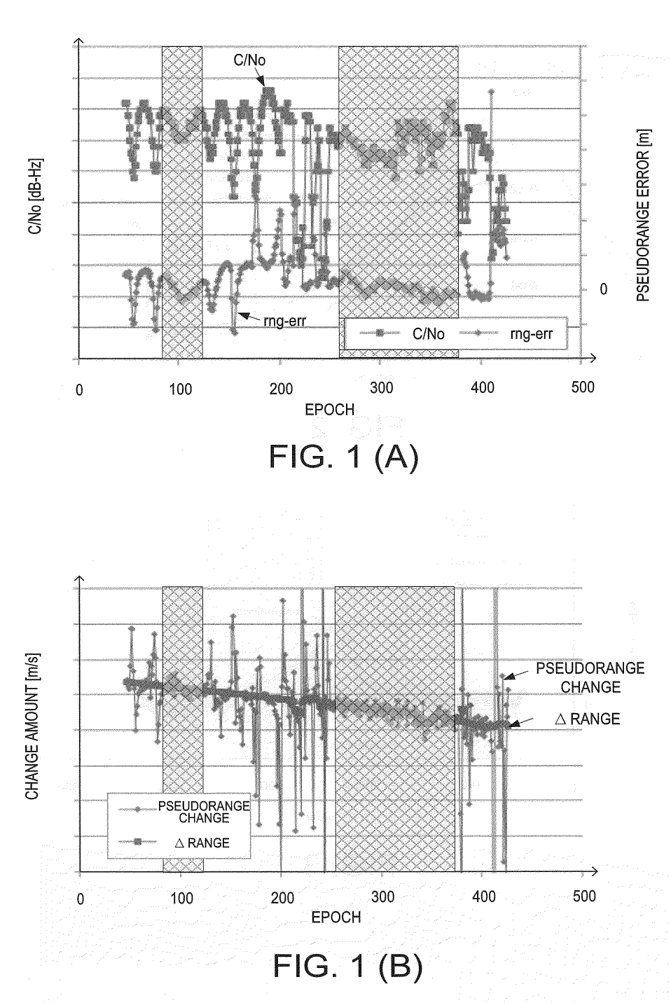

First, a concept of detecting multipath required in a pseudorange estimation calculation of the invention is described with reference to FIG. 1.

FIGS. 1(A) and 1(B) are charts illustrating multipath detection concepts of the invention, in which FIG. 1(A) is the chart showing a time transition of a C/No and a pseudorange error when a GPS signal from a specific single GPS satellite is received with time, and FIG. 1(B) is the chart showing a time transition of a pseudorange change and a delta range under the same condition as FIG. 1(A). This experiment is performed under a condition that the position of the own apparatus, that is a true pseudorange, is in a well-known state. Note that, the delta range corresponds to a Doppler shift.

Here, a pseudorange error Error(PR(iv)) in FIG. 1(A) is a difference value between a pseudorange PR(iv) and the true pseudorange at each epoch. The pseudorange PR(iv) is calculated based on a result of integrating code correlation results of the reception signals for a predetermined time length (e.g., for 1 second) toward the past based on each count timing.

A C/No (iv) in FIG. 1(A) is calculated based on the result of integrating the correlation results obtained by a two-dimensional correlation spectrum of the reception signals for a predetermined time length (e.g., for 1 second) toward the past based on each epoch. Note that, in this embodiment, although the correlation processing by the two-dimensional correlation spectrum is shown, it may be other correlation processing results.

A pseudorange change Rr(iv) in FIG. 1(B) is calculated based on a difference between a pseudorange PR(iv)ₖ at each epoch and a pseudorange PR(iv)ₖ₋₁ at an immediate previous epoch of the epoch.

A delta range DR(iv) in FIG. 1(B) is calculated by integrating Doppler frequencies of the reception signals for a predetermined time length (e.g., 1 second) based on the respective epoch.

Moreover, as shown in the hatched part of FIG. 1(A), in the time range between about 80 epoch and 120 epoch and the time range between about 250 epoch and 360 epoch, the pseudorange error Error(PR(iv)) is approximately “0”, and it is considered to be highly possible that multipath does not occur in those time ranges but more than a low level of multipath occurs in other time ranges.

Here, as shown in FIG. 1(B), it can be understood that the pseudorange change Rr(iv) stabilizes in the time range where multipath does not occur and it varies significantly in the time range where multipath occurs.

On the other hand, as shown in FIG. 1(B), the delta range (iv) is steady regardless of the occurrence of multipath. This is considered because the delta range depends on the Doppler frequency and thus it is not influenced by the occurrence of multipath.

Here, because the pseudorange change Rr(iv) is indicated by a change of distance in time, that is a unit of speed, and the delta range DR(iv) is a value that is an integrated value of Doppler frequencies indicated by the unit of speed, they can simply be used in four operations. By using this, a difference value DV(iv) is calculated through reducing the pseudorange change Rr(iv) by the delta range DR(iv). Because this difference value DV(iv) is a difference value between the pseudorange change Rr(iv) and the delta range DR(iv), it is substantially the same in the time range where the pseudorange change Rr(iv) is stable and multipath does not occur, and it varies significantly in the time range where the pseudorange change Rr(iv) is unstable and multipath occurs.

Further, as shown in FIG. 1(B), the pseudorange change Rr(iv) and the delta range DR(iv) have the same transition tendency of value in time transition. Therefore, the difference value DV(iv) becomes a value such that the pseudorange change Rr(iv) is standardized by the delta range DR(iv). In this manner, influence due to external factors other than multipath is suppressed and the time transition of the pseudorange change Rr(iv) can be observed.

Based on these characteristics, the difference value DV(iv), an average value DV(Av) and a standard deviation σ_{DV} calculated by using a plurality of the difference values DV(iv) are respectively set with thresholds that are obtained experimentally, and it is determined that multipath exists when multipath detecting conditions based on the thresholds are satisfied, and it is determined that multipath does not exist when the multipath detecting conditions are not satisfied.

Thus, when the existence of multipath is determined, carrier smoothing processing by the weighted hatch filter described subsequently is executed according to the existence of the multipath, and the pseudorange is estimately calculated.

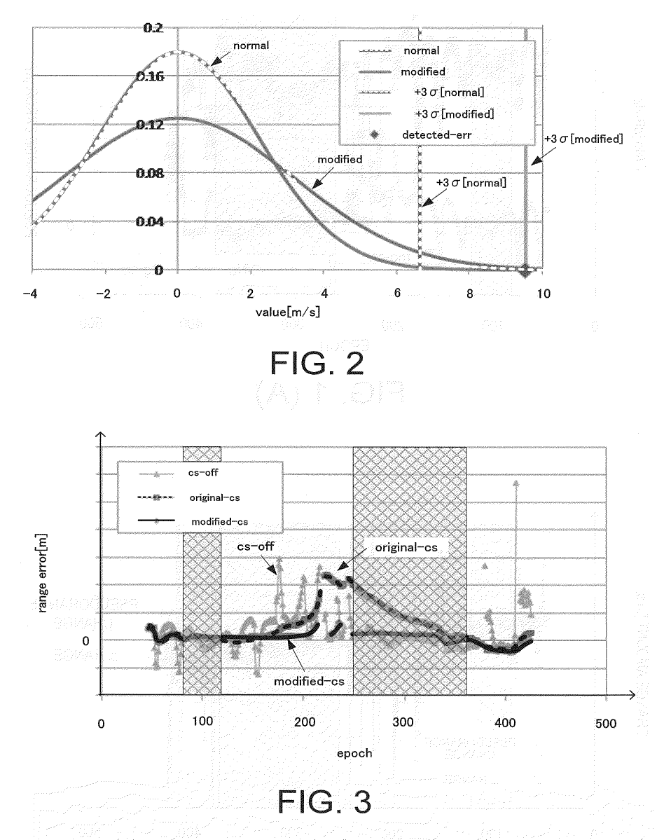

FIG. 2 is a chart showing the concept for setting weight coefficients of a weighted hatch filter which is used in the estimation calculation of the pseudorange of this embodiment.

First, the weighted hatch filter used in this embodiment is described. Equation 1 shown subsequently is a linear equation expressing the weighted hatch filter, wherein “k” indicates the epoch, PR(iv)ₖ indicates an observed pseudorange calculated based on observation values for k-th epoch, and PRe(iv)ₖ indicates an estimated pseudorange estimated for k-th epoch. DR(iv)ₖ is the delta range calculated for k-th epoch. σ²_{PRek-1} indicates an error variance of the observed pseudorange for k-th epoch, and a σ²_{PRek-1} indicates an error variance of the observed pseudorange for k-1th epoch.

$$\begin{matrix}\{ \begin{matrix}P {Re ( iv )}_{1} + {PR ( iv )}_{1} \\ \begin{matrix}{PRe ( iv )}_{k} = \frac{{σ}_{PRak - 1}^{2}}{{σ}_{PRk}^{2} + {σ}_{PRek - 1}^{2}} \cdot {PR ( iv )}_{k} + \\ \frac{{σ}_{PRk}^{2}}{{σ}_{PRk}^{2} + {σ}_{PRek - 1}^{2}} \cdot ( {PRe ( iv )}_{k - 1} + {DR ( iv )}_{k} )\end{matrix}\end{matrix} \\ Note that , & ( 1 ) \\ {σ}_{PRek}^{2} = \frac{{σ}_{PRk}^{2} \cdot {σ}_{PRek - 1}^{2}}{{σ}_{PRk}^{2} + {σ}_{PRek - 1}^{2}} . & ( 2 )\end{matrix}$$

In Equation 1, the observed pseudorange PR(iv)ₖ and the delta range DR(iv)ₖ which are state variables are observation values, and the error variance σ²_{PRek} of the estimated pseudorange used in the coefficients is calculated based on the error variance σ²_{PRk} of the observed pseudorange PR(iv)ₖ. Therefore, if the error variance σ²_{PRk} of the observed pseudorange PR(iv)ₖ used in the coefficients along with the error variance σ²_{PRek-1} of the estimated pseudorange can be set, the estimated pseudorange PRe(iv)ₖ can be calculated. Note that, in Equation 1, although the delta range DR(iv)ₖ is used in the correction term of carrier smoothing, a change of a carrier wave phase may also be used.

These coefficients are determined according to the existence of multipath.

First, when multipath does not exist, the pseudorange stabilizes as described above, and the pseudorange error becomes extremely small. Further, such a state can be created experimentally in advance. Therefore, based on such experimental result and simulation result, the error variance σ²_{PRk} described above is set to be a fixed value with which the estimated pseudorange can stably be obtained.

On the other hand, when multipath exists, the error variance σ²_{PRk} is set by using the standard deviation σ_{DVk} of the difference value DV(iv)ₖ calculated in the determination of the existence of multipath described above.

Here, the difference value DV(iv)ₖ is expressed in the following Equation 3.

DV(iv)ₖ=(PR(iv)ₖ−Pre(iv)ₖ₋₁)−Dr(iv)ₖ (3)

Further, through modifying Equation 3, Equation 4 is obtained.

PR(iv)ₖ=DV(iv)ₖ+PRe(iv)ₖ₋₁+DR(iv)ₖ (4)

Here, the equations do not correlate in the predetermined period (e.g., for 1 second). Therefore, the relation of each error variance can be expressed in Equation 5.

σ²_{PRk}=σ²_{DVk}+σ²_{PRek-1}+σ²_{DRk} (5)

Meanwhile, if multipath exists, the error variance σ²_{DVk} of the difference value DV(iv)ₖ becomes greater than the error variance in the case where multipath does not exist.

FIG. 2 is a chart showing a relation between, when the C/No of the reception signal is 35 [dB-Hz], a normal distribution of an average value of 0 [m/s] when a probability density function is calculated by using the C/No (corresponding to “normal”) and the standard deviation σ_{DVk} of the difference value DV(iv)ₖ when such C/No is used and multipath is determined to exist (128 epoch shown in FIG. 1) (corresponding to “modified”). The point of 9.54 [m/s] in FIG. 2 is a position that can be assumed to correspond to 3σ of the difference value DV(iv)ₖ, that is 3σ_{DVk}. Moreover, the position of 6.61 [m/s] in FIG. 2 indicates the position of 3σ_{CN} based on the probability density function using the C/No.

Note that, this σ_{CN} based on the probability density function using the C/No is calculated based on an approximate equation shown in the following Equation 5.

$${σ}_{CN} = {a}_{0} + {a}_{1} \cdot {e}^{- ( \frac{C / No ( iv )}{a 2} )} \qquad ( 6 )$$

As shown in FIG. 2, in a case such that multipath is determined to exist, 3σ_{DVk} of the difference value DV(iv)ₖ is not within the range of 3σ_{CN} obtained from the approximate equation based on the C/No and it is not likely that it follows the normal distribution. This is considered to be the influence of multipath.

Therefore, when multipath exists, it is assumed that 3σ_{DVk} of the calculated difference value DV(iv)ₖ follows the normal distribution, and the error variance σ²_{PRk} of the observed pseudorange PR(iv)ₖ is set based on Equation 5 by using 3σ_{DVk} of the difference value DV(iv)ₖ.

Here, the error variance σ²_{DRk} of the delta range DR(iv)ₖ is required. However, the delta range DR(iv) hardly receives the influence of multipath and is steady as described above, and therefore, it may be calculated in a well-known method based on a plurality of delta ranges DR(iv) that can be acquired in a predetermined time length (e.g., in 1 second).

Further, by using the error variance σ²_{PRk} of the observed pseudorange PR(iv)ₖ and the error variance σ²_{DRk} of the delta range DR(iv)ₖ, the error variance σ²_{PRek} of the estimated pseudorange PRe(iv)ₖ can be calculated based on Equation 2.

Further, in Equation 5, when substituting the error variance σ²_{PRek-1} of the previous estimated pseudorange, the correction by the error variance of the delta range is performed based on the following equation, and then the substitution into Equation 5 is performed.

σ²_{PRek-1}=σ²_{PRek-1}+σ²_{PRek} (7)

By performing this processing, the influence from the error of the error variance of the delta range can be suppressed.

The pseudorange estimation calculation result when the coefficient setting is performed as above is shown in FIG. 3. FIG. 3 is a chart showing pseudorange calculation results in the case where the weighted hatch filter is not used, in the case where the weighted hatch filter with the conventional weight setting is used, and in the case where the weighted hatch filter with the weight setting of this embodiment are used, respectively. In FIG. 3, cs-off indicates the case where the weighted hatch filter is not used, original-cs indicates the conventional case, and modified-cs indicates the case of this embodiment. Moreover, in FIG. 3, the hatched area indicates an epoch area where it is determined that multipath does not exist.

As shown in FIG. 3, when the weighted hatch filter is not used, the variation of the calculated pseudorange is larger, and particularly within the range when multipath exists, the variation is significantly larger. Alternatively, when the conventional weighted hatch filter with the weights being steady is used, although the pseudorange error becomes smaller in the period where multipath does not exist or immediately after the period is shifted from the period where multipath does not exist to the period where multipath exists, if the period where multipath exists is long, the error gradually becomes larger.

On the other hand, with the weighted hatch filter of this embodiment where the weights are changeable based on multipath, the pseudorange error is hardly generated in the period where multipath does not exist and the period where multipath exists.

This is because the weight coefficient is determined based on the error variance corresponding to the appearance of multipath, and by this processing, the influence of multipath is suppressed and the pseudorange can be estimately calculated in high accuracy.

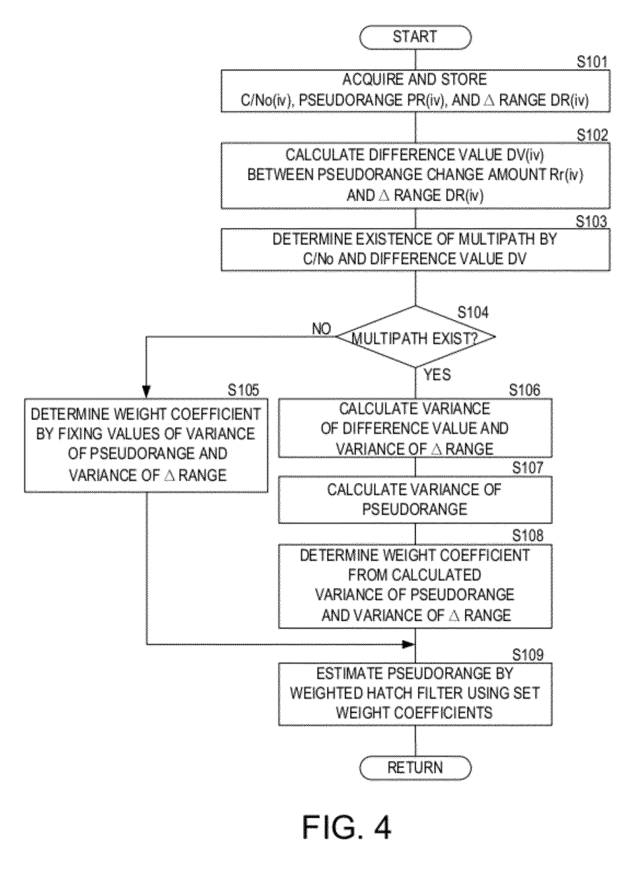

Next, the pseudorange estimation calculation method of this embodiment is described with reference to FIG. 4. FIG. 4 is a flowchart of the pseudorange estimation calculation method of this embodiment.

First, in the multipath detecting method of this embodiment, the C/No (iv), the pseudorange PR(iv), and the delta range DR(iv) are acquired at every count timing (e.g., every second) to be stored (S101). Here, the C/No (iv) is calculated based on the correlation result acquired from the two-dimensional correlation spectrum obtained during the period between the counting timings as described above (e.g., for 1 second), that is a correlation data distribution in the code phase axis and a correlation data distribution in the frequency axis. The pseudorange PR(iv) is calculated based on the code phases obtained during the period between the count timings as described above (e.g., for 1 second) by using a well-known method. The delta range DR(iv) is calculated by integrating the Doppler frequencies that are respectively obtained from carrier phase differences obtained during the period between the count timings as described above (e.g., for 1 second).

Next, the pseudorange change Rr(iv) is obtained by finding the difference between the pseudorange PR(iv) and an immediate previous pseudorange PR(iv) thereof. Further, a difference operation between the calculated pseudorange change Rr(iv) and the delta range DR(iv) is performed to calculate and store the difference value DV(iv) (S102). Note that, here, the delta range DR(iv) is also stored.

Next, it is determined whether the numbers of data corresponding to the sampling numbers for calculating an average value C/No(Av) and a standard deviation σ_{C/No} of the C/No and an average value DV(Av) and a standard deviation σ_{DV} of the difference values exist, respectively. Here, if the predetermined numbers of data cannot be acquired, it is defined to be indeterminable. On the other hand, if the predetermined numbers of data can be acquired, the average value C/No(Av) and the standard deviation σ_{C/No} of the C/No and the average value DV(Av) and the standard deviation σ_{DV} of the difference values are calculated.

Further, after the average value C/No(Av) and the standard deviation σ_{C/No} of the C/No and the average value DV(Av) and the standard deviation σ_{DV} of the difference values are calculated, it is determined whether multipath exists based on the C/No (iv), the difference value DV(iv), the average value C/No(Av) and the standard deviation σ_{C/No} of the C/No, and the average value DV(Av) and the standard deviation σ_{DV} of the difference values (S103).

Here, the existence of multipath is determined as follows. For example, when the C/No (iv) is above a threshold for an individual measurement value of a preset C/No and the difference value DV(iv) is below a threshold for an individual measurement value of a preset difference value, it is determined that multipath does not exist. Next, if this condition is not satisfied, the average value C/No(Av) and the standard deviation σ_{C/No} of the C/No reach predetermined values for the C/No and the average value DV(Av) and the standard deviation σ_{DV} of the difference values reach predetermined values for the difference value, it is determined that multipath does not exist. Note that, when the condition for the individual measurement and the condition for the average value are all satisfied, it may be determined that multipath does not exist.

Next, if multipath is determined as it does not exist (S104: NO), through setting the error variance σ²_{PR} of the observed pseudorange PR(iv) and the error variance σ²_{DR} of the delta range DR(iv) to preset fixed values, the weight coefficient is determined (S105).

On the other hand, if multipath is determined as it exists (S104: YES), the error variance σ²_{DVk} is calculated based on the current standard deviation σ_{DVk} of the difference values calculated at the time of the multipath determination described above, and, among a group of stored delta ranges DR(iv) for the recent predetermined time length (e.g., for 1 second), the current error variance σ²_{DRk} of the delta range is calculated (S106).

Next, by using these standard deviation σ_{DVk} of the difference values, the error variance σ²_{DRk} of the delta range, and an error variance σ²_{PRek-1} of the previous estimated pseudorange, the error variance σ²_{PRk} of the current observed pseudorange is calculated based on Equation 2 (S107).

Next, the weight coefficient is determined from the calculated error variance σ²_{PRk} of the current observed pseudorange and the error variance σ²_{PRek-1} of the previous estimated pseudorange (S108).

Next, after the weight coefficient is determined at Step S105 or S108, the current observed pseudorange PR(iv)ₖ, the previous estimated pseudorange PRe(iv)ₖ₋₁, and the current delta range DR(iv)ₖ are substituted into the weighted hatch filter indicated in Equation 1 to calculate the current estimated pseudorange PRe(iv)ₖ (S109). This calculation result is outputted to, for example, a positioning operator as well as being stored therein, and it is used in the estimation calculation of the pseudorange thereafter.

Thus, by using the pseudorange estimation calculation method of this embodiment, the pseudorange can be estimately calculated without being influenced by the existence of multipath.

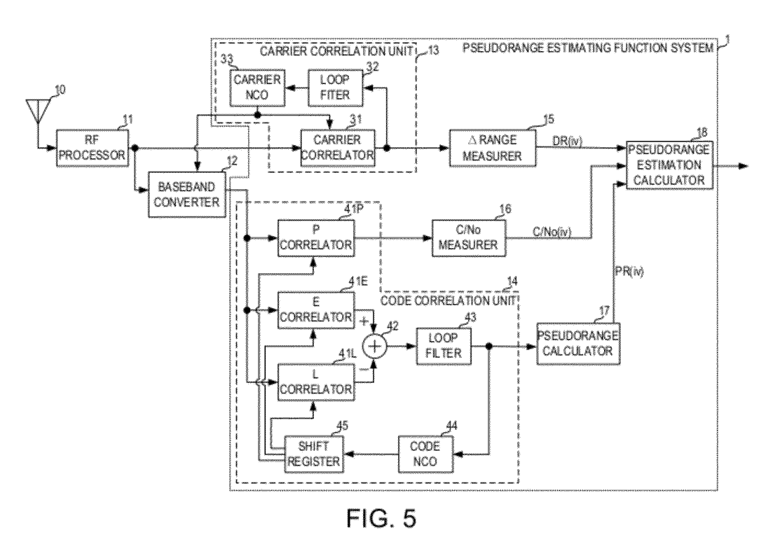

Next, a configuration of the system for achieving such pseudorange estimation calculation processing is described with reference to the drawings. FIG. 5 is a block diagram showing a main configuration of the pseudorange estimating function system of this embodiment.

As shown in FIG. 5, the pseudorange estimating function system 1 of this embodiment includes a carrier correlation unit 13, a code correlation unit 14, a delta range measurer 15, a C/No measurer 16, a pseudorange calculator 17, and a pseudorange estimation calculator 18. Although an example of configuring the carrier correlation unit 13 and the code correlation unit 14 in separate loops is shown in this embodiment, a so called code-carrier integrated tracking loop in which a so called code correlation result is used in carrier correlation processing and the carrier correlation result is used in code correlation processing.

These carrier correlation unit 13 and the code correlation unit 14 are connected with a baseband convertor 12. The baseband converter 12 is inputted with an IF signal obtained through down-converting a GPS signal received by an antenna 10 to an intermediate frequency by an RF processor 11. The baseband converter 12 uses a carrier frequency signal from a carrier NCO 33 of the carrier correlation unit 13 to convert the IF signal into a code signal of the baseband and outputs it to the code correlation unit 14.

The carrier correlation unit 13 includes a carrier correlator 31, a loop filter 32, and the carrier NCO 33. The carrier correlator 31 multiplies the carrier frequency signal from the carrier NCO 33 by the IF signal of the RF processor 11 and outputs a carrier phase difference therebetween. The outputted carrier phase difference is fed back to the carrier NCO 33 via the loop filter 32. Further, the carrier phase difference is also outputted to the delta range measurer 15.

The code correlation unit 14 includes a P correlator 41P, an E correlator 41E, an L correlator 41L, an adder 42, a loop filter 43, a code NCO 44, and a shift register 45.

The code correlation unit 14 is a correlation unit for performing code tracking by performing a so called Early-Late correlation.

The P correlator 41P multiplies a Punctual replica code by the code signal from the baseband convertor 12 and outputs Punctual phase difference data. The E correlator 41E multiplies an Early replica code of which a code phase is ½ chip ahead of the Punctual replica code by the code signal from the baseband convertor 12 and outputs Early phase difference data. The L correlator 41L multiplies a Late replica code of which a code phase is ½ chip behind the punctual replica code by the code signal from the baseband convertor 12 and outputs Late phase difference data. Note that, in this embodiment, although each phase difference among the Early, Punctual and Late is ½ chip, it may suitably be set according to the situation.

The adder 42 finds a difference between the Early phase difference data and the Late phase difference data, and creates E-L correlation data. The E-L correlation data is fed back to the code NCO 44 via the loop filter 43 as well as outputted to the pseudorange calculator 17.

The code NCO 44 creates a replica code based on the E-L correlation data, and outputs it to the shift register 45. The shift register 45 creates an Early replica code, a Punctual replica code, and a Late replica code of which the code phases vary by ½ chip from each other, based on the replica code from the code NCO 44. The punctual replica code is outputted to the P correlator 41P, the Early replica code is outputted to the E correlator 41E, and the Later replica code is outputted to the L correlator 41L in synchronization thereto, respectively.

The delta range measurer 15 calculates the delta range DR(iv) by calculating the Doppler frequency based on the carrier phase difference and integrating the predetermined time length of the Doppler frequencies (e.g., 1 second).

The C/No measurer 16 stores the Punctual phase difference data from the code correlation unit 14 for the predetermined time length (e.g., for 1 second), performs frequency conversion processing, such as FFT processing, on a plurality of stored Punctual phase difference data aligned on a time axis, and measures the C/No (iv) based on the two-dimensional correlation spectrum configured with a spectrum on the time axis and the spectrum on a frequency axis.

The pseudorange calculator 17 calculates the pseudorange PR(iv) by a well-known method based on the E-L correlation data from the code correlation unit 14.

The pseudorange estimation calculator 18 calculates the difference value DV(iv) as described above, based on the delta range DR(iv) from the delta range measurer 15 and the pseudorange PR(iv) from the pseudorange calculator 17. The pseudorange estimation calculator 18 performs the multipath determination by the individual measurement values based on the difference value DV(iv) and the C/No (iv) from the C/No measurer 16, and performs the multipath determination by continuous values based on the average value DV(Av) and the standard deviation a_{DV}(Av) of the difference values, the average value C/No(Av) of the C/No, and the standard deviation σ_{C/NO}(Av) of C/No which are obtained from the difference value DV(iv) and the C/No (iv).

Next, if it is determined that multipath does not exist, the pseudorange estimation calculator 18 estimately calculates the pseudorange PRe(iv)ₖ by using the weighted hatch filter indicated in Equation 1 where the weight coefficients constituted with the fixed value is set.

On the other hand, if it is determined that multipath exists, the pseudorange estimation calculator 18 calculates the error variance σ²_{PRk} of the current observed pseu dorange by using Equation 2 based on the standard deviation σ_{DVk} of the difference values according to the appearance of multipath, the error variance σ²_{DRk} of the delta range, and the error variance σ²_{PRek-1} of the previous estimated pseudorange, as described above. Moreover, the pseudorange estimation calculator 18 estimately calculates the pseudorange PRe(iv)ₖ by using the weighted hatch filter indicated in Equation 1 where the weight coefficients constituted with the error variance σ²_{PRk} of the current observed pseudorange and the error variance σ²_{PRek-1} of the previous estimated pseudorange are set.

Note that, in the description above, the example in which the pseudorange estimation calculation method described above is achieved with configuration constituted with function blocks is shown. However, he pseudorange estimation calculation method described above may be programmed and stored in a memory so as to execute a pseudorange estimation calculation by a CPU performing a processing operation of the program.

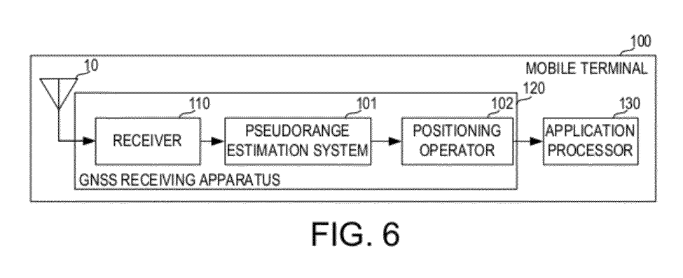

Moreover, such a pseudorange estimating function is used in a mobile terminal 100 as shown in FIG. 6. FIG. 6 is a block diagram showing a main configuration of the mobile terminal 100 having the pseudorange estimating function of this embodiment.

The mobile terminal 100 as shown in FIG. 6 is, for example, a mobile phone, a car navigation system, a PND, a camera, or a watch, and includes the antenna 10, a receiver 110, a positioning apparatus 120, and an application processor 130.

The antenna 10 is the same as the antenna shown in FIG. 5, and the receiver 110 is a function unit corresponding to the FR processor 11 and the baseband converter 12 of FIG. 5.

A pseudorange estimation system 101 of the positioning apparatus 120 corresponds to the pseudorange estimating function system described above, and a positioning operator 102 of the positioning apparatus 120 performs positioning of a position of the own apparatus, and outputs the positioning result to the application processor 130. Note that, the receiver 110, the pseudorange estimation system 101, and the positioning operator 102 may function as the GNSS receiving apparatus 120 to use the GNSS receiving apparatus 120 as an independent apparatus.

Based on the obtained positioning result, the application processor 130 displays the position of the own apparatus and executes processing for being used in navigation, etc.

According to such a configuration, since a highly accurate pseudorange as described above can be obtained, a highly accurate positioning result is obtained, and a highly accurate position display, navigation and the like can be achieved.

### DESCRIPTION OF NUMERALS

1 Pseudorange Estimating Function System
10 Antenna
11 RF Processor
12 Baseband Converter
13 Carrier Correlation Unit
31 Carrier Correlator
32 Loop Filter
33 Carrier NCO
14 Code Correlation Unit
41P P Correlator
41E E Correlator
41L L Correlator
42 Adder
43 Loop Filter
44 Code NCO
45 Shift Register
15 Delta Range Measurer
16 C/No Measurer
17 Pseudorange Calculator
18 Pseudorange Estimation Calculator
100 Mobile Terminal
101 Pseudorange Estimation System
102 Positioning Operator
110 Receiver
120 GNSS Receiving Apparatus
130 Application Processor

1. A method of estimating a pseudorange based on reception signals of GNSS positioning signals, comprising:
calculating an observed pseudorange based on a code phase difference of the reception signals;
measuring Doppler frequencies of the reception signals; and
calculating an estimated pseudorange by using carrier smoothing of adding with weights, the observed pseudorange calculated based on the code phase difference, a previously estimated pseudorange, and a change of a carrier wave phase, wherein the weight in the carrier smoothing is determined based on a change rate of the observed pseudorange and the Doppler frequency.

2. The pseudorange estimating method of claim 1, wherein the weight in the carrier smoothing is determined based on a difference value between the change rate of the observed pseudorange and the Doppler frequency, or a statistic of the difference values.

3. The pseudorange estimating method of claim 1, wherein the weight in the carrier smoothing is determined based on the change rate of the observed pseudorange, the Doppler frequency, and the estimated pseudorange.

4. The pseudorange estimating method of claim 3, wherein the weight in the carrier smoothing is determined based on a statistic of difference values between the change rate of the observed pseudorange and the Doppler frequency, and a statistic of the estimated pseudoranges.

5. The pseudorange estimating method of claim 1, wherein the calculating the estimated pseudorange includes adding with the weights, a value based on the Doppler frequency alternative to the change of the carrier wave phase.

6. The pseudorange estimating method of claim 1, comprising detecting multipath contained in the reception signal, wherein the calculating the estimated pseudorange includes determining, when multipath is detected in the detecting multipath, the weight in the carrier smoothing based on the change rate of the observed pseudorange and the Doppler frequency, and determining, when multipath is not detected, the weight in the carrier smoothing to be a predetermined value.

7. (canceled)

8. (canceled)

9. A GNSS receiving apparatus for performing positioning based on reception signals of GNSS positioning signals, comprising:
a receiver for receiving the GNSS positioning signals;
an observed pseudorange calculator for calculating an observed pseudorange based on a code phase difference of the reception signals;
a Doppler frequency measurer for measuring Doppler frequencies of the reception signals;
an estimated pseudorange calculator for calculating an estimated pseudorange by using carrier smoothing of adding with weights, the observed pseudorange calculated based on the code phase difference, a previously estimated pseudorange, and a change of a carrier wave phase; and
a positioning operator for performing a positioning operation by using the estimated pseudoranges, wherein the weight in the carrier smoothing is determined based on a change rate of the observed pseudorange and the Doppler frequency.

10. The GNSS receiving apparatus of claim 9, further comprising a multipath detector for detecting a multipath contained in the reception signal, wherein the estimated pseudorange calculator determines, when multipath is detected by the multipath detector, the weight in the carrier smoothing based on the change rate of the observed pseudorange and the Doppler frequency, and determining, when multipath is not detected, the weight in the carrier smoothing to be a predetermined value.

11. A mobile terminal, comprising:
the GNSS receiving apparatus of claim 9; and
an application processor for executing a predetermined application by using a positioning operation result from the positioning operator.
